(19) United States
(12) Patent Application Publication
(10) Pub. No.: US 2009/0217173 A1
(43) Pub. Date: Aug. 27, 2009

(54) Method and System For A Rich Media User Interface

(76) Inventor: Josh Manheimer, (US)

Correspondence Address: Josh Manheimer, P.O. Box 1690, Norwich, VT, 05055, US

(21) Appl. No.: 12/036,221

(22) Filed: Feb. 23, 2008

(51) Int. Cl. G06F 3/048

(52) U.S. Cl. 715/744; 715/835

(57) ABSTRACT

A method and system may generate a graphical user interface at a client on a network. An image of a physical container capable of being opened may be generated. One or more icons, each associated respectively with one or more rich media objects, may be displayed. The graphical user interface may display a rich media object associated with an icon when the icon is selected.

### FIELD OF THE INVENTION

The present invention relates to graphical user interfaces (GUI's) for displaying or presenting rich media and other digital media such as for advertising.

### BACKGROUND OF THE INVENTION

The advent of interactive advertising such as, for example, as delivered over the internet and other public networks has provided advertisers an alternative path for reaching consumers beyond traditional direct mail advertising. The success of such interactive advertising may then benefit from the potential opportunities to present consumers with diverse media beyond the printed media found in direct mail advertising. These media may include rich media for example, animation, audio, video, and slide shows among others as well as other digital media such as documents and images.

For a number of reasons including cost efficiencies and higher successful conversions, interactive ads may be targeted to individual consumers or consumer groups based on relevancy to a need or interest or possibly in response to a query to, for example, a search engine. Technology for serving content-relevant advertising systems has been disclosed in the prior art. For example, U.S. Pat. No. 7,136,875 (“SERVING ADVERTISEMENTS BASED ON CONTENT”) describes a method and apparatus for serving ads relevant to the content of a document such as a web page. Technology for serving ads with email has been disclosed, for example in U.S. Pat. No. 7,203,684 (“SERVING CONTENT-TARGETED ADS IN E-MAIL, SUCH AS E-MAIL NEWSLETTERS”).

However, the familiarity and comfort level of consumers with the rich media or multimedia formats may vary considerably. Therefore, it may be desirable to present consumers with interactive advertising in a familiar format.

### SUMMARY OF THE INVENTION

The present invention provides a method and apparatus for presenting or displaying rich media information. In one embodiment of the present invention, a GUI is provided that includes

### BRIEF DESCRIPTION OF THE DRAWINGS

Specific embodiments of the present invention will be described with reference to the following drawings, wherein:

FIG. 1 is a simplified block diagram of a system for generating a GUI to control the display of rich media objects in accordance with an embodiment of the invention.

FIG. 2 is an illustration of a first view of a GUI for controlling the display of rich media objects in accordance with an embodiment of the invention.

FIG. 3 is an illustration of a second view of a GUI for controlling the display of rich media objects in accordance with an embodiment of the invention.

FIG. 4 is an illustration of a third view of a GUI for controlling the display of rich media objects in accordance with an embodiment of the invention.

FIG. 5 is an illustration of a fourth view of a GUI for controlling the display of rich media objects in accordance with an embodiment of the invention.

FIG. 6 is a flowchart showing a method for controlling the display of rich media objects in accordance with an embodiment of the invention.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

When used herein, rich media may include digital interactive media that have a dynamic element such as for example animation, audio, video, and slide shows among others. The dynamic element or motion may be automated or in response to user interaction or input. Rich media may be downloadable such as from a web site on the Internet using the World Wide Web or may be embedded in a web page of a web site with for example a Java script. Further, some instances of rich media may require the installation of specific plug-in or components for display such as for example a media player or an ActiveX component as known in the art.

Digital media may include presentation files such as those in the Microsoft PowerPoint® format or other formats which may or may not be animated, animated files such as those in the Macromedia Flash® format, documents such as those in the Microsoft Word® or WordPerfect™ format or other formats, video files such as those in an .avi, .mpg or other format, audio files such as those in a .wav or other format, images such as those in a .jpg, .gif or other format, and other types of digital files as known.

When used herein, displaying of rich media and/or digital media may include for example displaying images, playing videos, playing audio files, presenting slide shows, as well as other techniques for presenting the contents of the respective objects or files.

Embodiments of the present invention include a system and method for generating a GUI for displaying a plurality of rich media objects configured for example as the contents of an envelope or other physical container displayed on the user's screen, thereby emulating the experience of a user's receipt of a package and subsequent viewing of the materials contained therein. Upon clicking on or opening the package, e.g. a physical container, the contents may appear as icons or symbols with one or more rich media objects or files associated with each icon. Clicking on an icon may activate or play the associated rich media object or file. In some embodiments, the GUI may be personalized to the user by display of a text message or other addressing. In some embodiments, the GUI may be dynamic, e.g. may change in response to a user input, a timeout, or other activating or triggering mechanism for transitions.

In some embodiments, an Internet or web server may host a web site providing separate links or references such as hyperlinks to files associated with each icon in the display

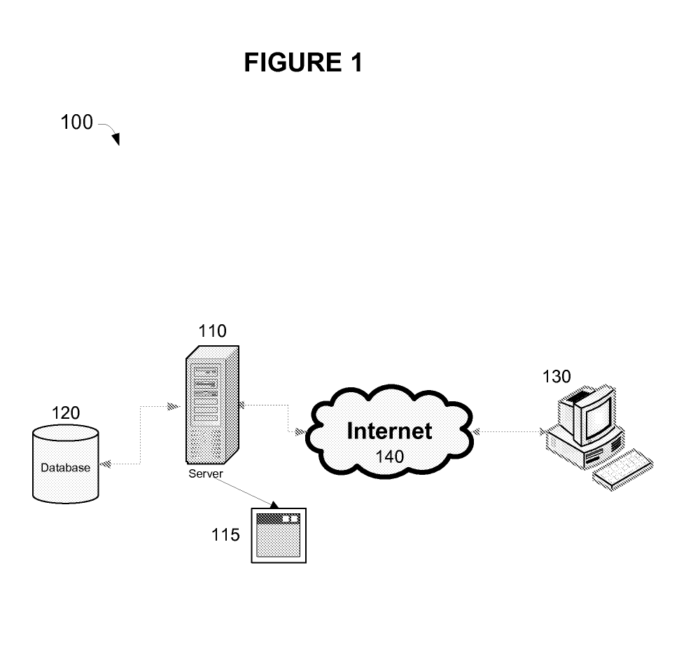

FIG. 1 depicts a simplified block diagram of a system for generating a GUI to display rich media in accordance with an embodiment of the present invention. System 100 may include a server 110 for hosting or executing a web site or other application capable of serving rich media and other digital content, an associated database 120, a web host 115, and a user workstation 130 connected to a public network 140, which may be for example the Internet. Server 110 may be or include any computer capable of hosting a process as disclosed herein, and applications for interacting with, for example, web advertisers and users. Some embodiments of the present invention may include an application capable of generating code or plug-ins in a programming language compatible with incorporation on certain websites, such as, for example, in JavaScript. This application may also be capable of interacting with browsers or other applications for retrieving and viewing web content.

Database 120 may be or include any software process or application for storing and retrieving data, files, or a plurality of documents, such as a database system such as, e.g., a relational database, although other file storage systems may be used. Files stored in the database may include content on a broad variety of subject matter that may be relevant to an advertisement being displayed to a user. This content may be stored as rich media files in various formats as known in the art. Rich media objects or files may be input to database 120 via methods as known. For example, some embodiments may include a software tool for content owners to incorporate their content into database 120 at their convenience or when published. In alternate embodiments rich media objects provided by server 110 to client websites may not be located in database 120. In yet other alternate embodiments rich media objects may be embedded in a web page accessible by a user. In yet another embodiment, the GUI and rich media objects may be delivered to user workstation 130 directly, for example, via email and may execute exclusively on the user workstation 130.

Web host 115 may be or include any computer or computer system capable of hosting a web site, typically composed of individual web pages, as is commonly known in the art. Each web page may be written in Hypertext Markup Language (HTML) or other suitable language as is known. A web page may also include one or more frames for displaying additional content not present on the web page.

A user may access web host 115 via for example workstation 130 which may be for example any general purpose computer capable of supporting any application for retrieving and viewing web content, or any other suitable device such as a cell phone, personal digital assistant (PDA), video game console, etc. Although not limited in this respect, some embodiments of the present invention may incorporate for example an Internet or web browser as an application for interfacing with server 110 or web host 115 such as for example Internet Explorer®, Firefox®, Netscape®, Opera©, or Safari®. Such web browsers are commonly installed (or easily installed) on computing devices, and may retrieve content from the Internet using a client-server dialogue including requests from the browser and responses from a web site or other server. Such web browsers may work in concert with other commonly installed software applications such as Quicktime®, Windows Media Player®, RealPlayer®, PowerPoint®, Adobe Reader®, or Microsoft Word®, possibly with the installation of the commonly distributed corresponding plug-ins that are integrated into or used with the web browsers when installed. Some embodiments of the invention may not require these plug-ins for showing display files derived from or used with these applications.

Public network 140, which connects server 110, web host 115 and workstation 130, may be any publicly accessible network such as the Internet. Access to public network 140 may be through wire line, terrestrial wireless, satellite or other systems well known in the art. Alternatively a private network may be used instead of or in conjunction with public network 140 to connect workstation 130 with server 110 and/or web host 115.

Although not shown in FIG. 1, workstation 130 may include memory and/or other machine readable medium and executable code that provides functionality for operating a web browser and/or operating a GUI according to embodiments of the present invention. Such machine-readable medium may store executable code and/or other data to provide one or a combination of mechanisms for operation of a web browser and/or a GUI, according to embodiments of the invention. A machine-readable medium may be or include one or a combination of various types of media/devices for storing machine-readable data and may include, but is not limited to one or a combination of a magnetic storage space (e.g., a hard or floppy disk), magneto-optical storage, tape, optical storage (e.g., CD ROM, DVD, etc.), dynamic random access memory (DRAM), static RAM (SRAM), flash memory, etc.

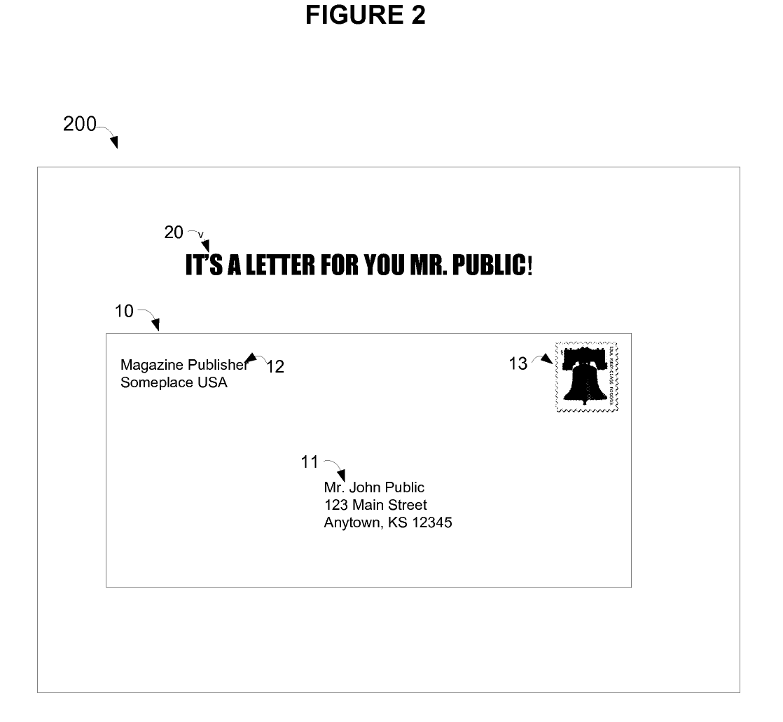

Reference is now made to FIG. 2 which is an illustration of a first view of GUI 200 for controlling the display of rich media objects in accordance with an embodiment of the invention. GUI 200 may be implemented for example as an embedded object on a web page on a web site hosted by server 110, although the invention is not limited in this respect. Other techniques for displaying GUI 200 on workstation 130 as known may also be used. Web host 115 may display GUI 200 to a user or consumer with a web browser with or without any plug-ins or other specialized software. GUI 200 may respond to user's commands as input through GUI 200.

GUI 200 may include for example a container image 10 and a message 20, although other images, messages, or icons may also be included. As used herein, images and other objects such as for example icons displayed in GUI 200 may function as user controls or mechanisms for activating other features such as the display of rich media.

Image 10 may be or include an image of a physical container or package that may for example be familiar to a recipient of direct mail advertising, and that may have visibly displayed a user identifier 11, an advertiser identifier 12. Other identifiers and/or images may also be included. For example if image 10 is an image of an envelope, image 10 may also display stamp 13 to further convey the familiarity of image 10 and user identifier 11 may be a mailing address of the user and advertiser 12 may be a return address of the advertiser. Other identifiers may also be used.

Message 20 may be or include a message for the user and may indicate the nature of the advertisement. In some embodiments, message 20 may be personalized or addressed to the user as the recipient of the physical container in image 10 by any technique as well known in the art. For example, if image 10 shows an envelope, message 20 may be of the form of a line of text stating “It's a letter for you USER NAME.” Other text and other message formats including rich media formats are also possible.

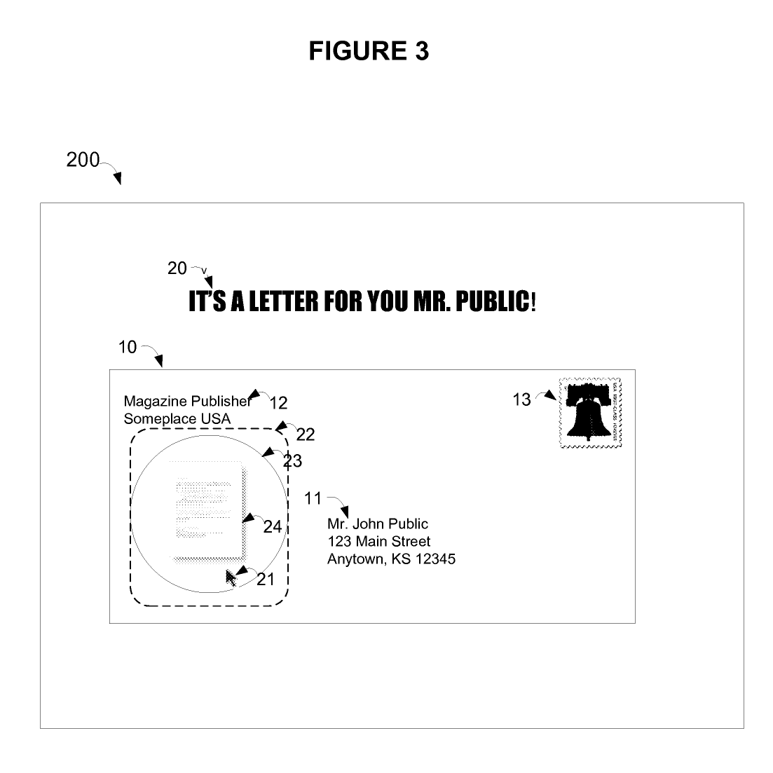

Reference is now made to FIG. 3 which shows a second view of GUI 200 for controlling the display of rich media objects in accordance with an embodiment of the invention. In the view of FIG. 3, a cursor 21 may be present on or over image 10. Cursor 21 may be under the control of a user through a pointing device such as a mouse, trackball, touchpad, arrow keys of a keyboard, etc., and may enable a user to control features of GUI 200. Various features or controls of GUI 200 may be activated by movement of the cursor and/or by holding down one or more buttons of the pointing device, e.g. “clicking” on an object or control. Alternatively, pressing one or more keys on a keyboard such as for example the “Enter” key may activate features or controls of GUI 200. Other techniques to activate the controls such as for example voice activation are also possible.

In the view of GUI 200 in FIG. 3, an area 22 of image 10 may be associated with a window 23 and a corresponding content icon 24. Window 23 may be an image of content icon 24, a rich media object or other mechanism for displaying content icon 24. Content icon 24 may be an image or representation of one or more contents of the physical container shown in image 10. For example, if image 10 is an image of an envelope, content icon 24 may represent a letter contained in the envelope and window 23 may appear sufficiently large so as show all of content icon 24. In some embodiments, a plurality of areas 22 may be associated with a plurality of windows 23 and corresponding content icons 24 which in turn may represent a number of different contents of the physical container of image 10.

When cursor 21 is moved over area 22, GUI 200 may display content icon 24 or activate window 23 to display content icon 24, although the invention is not limited in this respect. Other mechanisms for activating window 23 to display content icon 24 as being the contents of the physical container in image 10 being delivered to a user are also possible. It is an advantage of embodiments of the present invention that such a display of content icons 24 may emulate a user's trying to determine the contents of a physical container or package that has been delivered prior to opening the package. By displaying one or more different content icons 24 when moving cursor 21 over one or more other distinct areas 22, a user may discover that the physical package may contain more than one item. For example, multiple content icons 24 may in turn represent a letter, an RSVP note, pictures or images, a video or audio file, and the like. Other content icons 24 representing other contents are also possible.

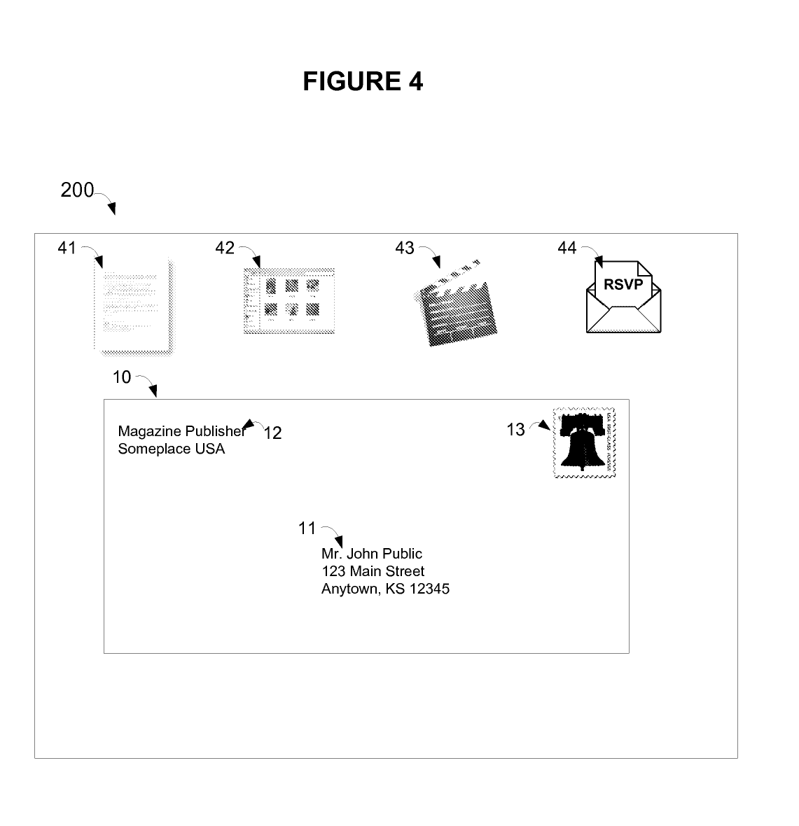

Reference is now made to FIG. 4 which shows a third view of GUI 200 for controlling the display of rich media objects in accordance with an embodiment of the invention. In the view of FIG. 4, one or more icons each representing an item contained the physical package of image 10 may appear in GUI 200. For example in the view of FIG. 4, the physical package of image 10 may container a letter as represented by letter icon 41, a slide show as represented by slide show icon 42, a video as represented by video icon 43, and an RSVP card as represented by RSVP icon 44, although the invention is not limited in this respect. Other icons representing other contents of the physical package of image 10 may also be included in GUI 200. Further, in some embodiments, the one or more content icons 24 shown in FIG. 3 may be the same as or may correspond to the icons shown in FIG. 4. Alternatively, different icons may be used.

In some embodiments, the images displayed in GUI 200 may change through animation or other rich media mechanism known in the art from the view of FIG. 3 to the view of FIG. 4. Alternatively, GUI 200 may show the change as a simple replacement of the view of FIG. 3 with the view of FIG. 4. Other transitions are also possible. Such a transition from the view of FIG. 3 to the view of FIG. 4 may be activated or initiated when a user selects image 10 in the view of FIG. 3 such as for example when a pointing device is clicked while cursor 21 is anywhere over image 10. Alternatively or additionally, the transition may be activated when the user selects message 20 while cursor 21 is over message 20 and the pointing device is clicked. Other mechanisms for initiating the transition such as for example based on timing are also possible.

In some embodiments, the transition from the view of FIG. 3 to the view of FIG. 4 may be portrayed as the opening of the physical package of image 10. It is an advantage of the present invention that displaying the content(s) of the physical package of image 10 after the package is selected may appear to the user as a familiar technique such as would be done with a package that has been delivered for example to a home or office. For users who may not be particularly skilled in the use of computers or the Internet, the familiarity of such an action may increase the user receptiveness to the message being delivered by for example an advertiser using the present invention.

Each of the icons 41-44 may be associated with an image file, graphic, or rich media file or object. GUI 200 may display, begin, or activate the image, graphic, rich media file, etc. associated with an icon when the icon is selected such as for example by passing cursor 21 over the icon, clicking on the icon, or other techniques known in the art. Alternatively, the different rich media associated with icons 41-44 may be activated on a predetermined timed basis.

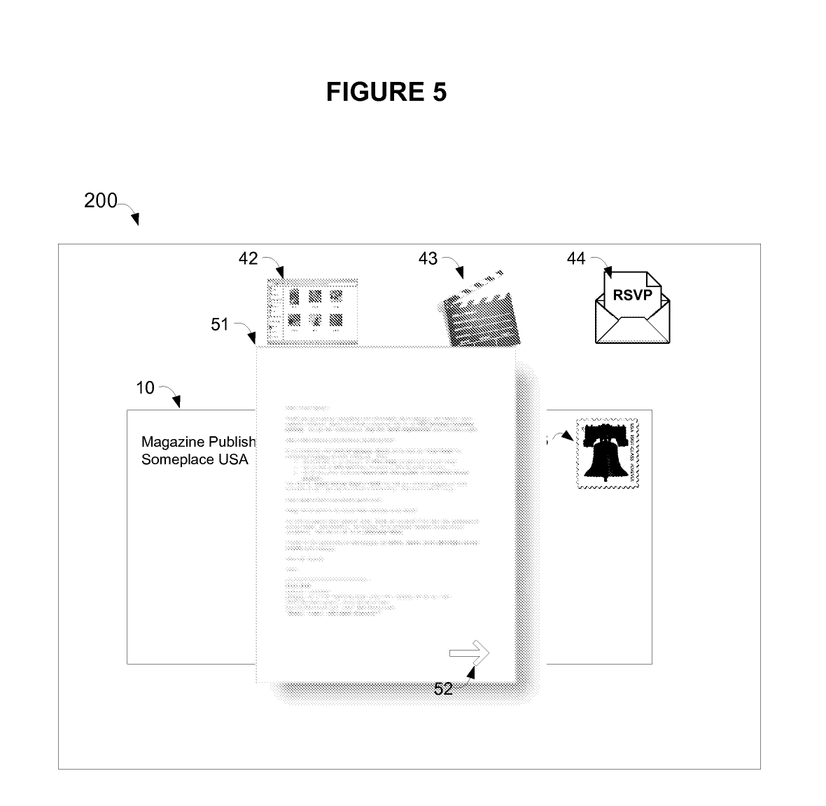

Reference is now made to FIG. 5 which shows a fourth view of a GUI for controlling the display of rich media objects in accordance with an embodiment of the invention. In some embodiments, the view of FIG. 5 may include one or more of the same images, icons, etc. as in the view of FIG. 4. However, the view of FIG. 5 may differ from that of FIG. 4 in that one or more of the icons 41-44 may have been selected and removed, and an image of the contents or a rich media file represented by the icon may be displayed by GUI 200. Alternatively, GUI 200 may display both the icon and the image.

In the embodiment of FIG. 5, icon 41 has been selected and removed, and GUI 200 is displaying a letter image 51. Letter image 51 may be of sufficient size so as to be read by a user and may include an advertising message or other text, although the invention is not limited in this respect. Letter image 51 may additionally or alternatively be the first page of a letter and may include a page turning icon 52 or other such control as is known.

The effect of selecting one of icons 41-44 may vary and depend on the rich media file represented by the icon. For example, if slide show icon 42 is selected, GUI 200 may display a first slide of the slide show and, in some embodiments, user controls as known for controlling the slide show. Similarly, if video icon 43 is selected, GUI 200 may activate and display a video file in a separate window with corresponding play, pause, stop, rewind, and volume controls. If RSVP icon 44 is selected, GUI 200 may show an interactive set of fields for a user to respond by ordering a product being advertised using the present invention. These response fields may appear as part of an image of an order form such as may be included with direct mail advertising.

In some embodiments, one or more of the image files, graphics, rich media objects, etc. necessary for GUI 200 to display the relevant content may be downloaded from server 110 after one of icons 41-44 is selected. Alternatively, one or more of the rich media objects etc. may be downloaded when GUI 200 first displays image 10 or at another appropriate time. Further, GUI 200 may link to another web site or web page in response to the selection of an icon or other triggering mechanism.

In some embodiments, GUI 200 may no longer show letter image 51 once a second icon is selected, and may show instead the rich media object or file associated with the second icon. Alternatively, GUI 200 may move letter image 51 to a background position, shrink letter 51, or replace letter 51 with icon 41. Other changes in reaction to the selection of second icon are also possible. In some embodiments, GUI 200 may change the appearance of icons 41-44 or employ another mechanism to indicate that one or more icons have been selected and their corresponding rich media have been viewed.

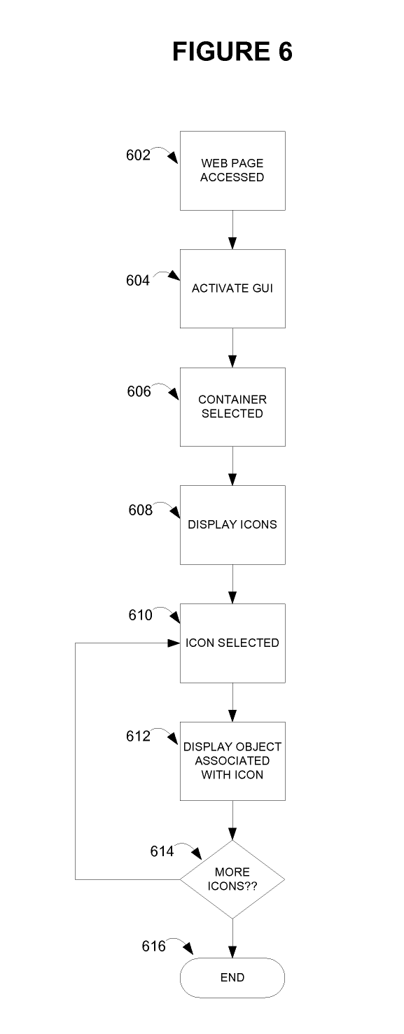

Reference is now made to FIG. 6, which is a flowchart illustration of a method for displaying rich media objects in accordance with some embodiments of the present invention. While operations are assigned to a web host 115, a server such as server 110, and a workstation such as workstation 130 as these entities are described herein, in other embodiments the operations may be performed by different entities, having different structures. Furthermore, other or different operations or sequences may be performed.

A user may load a web page that may be or include an advertisement or other content from a web site with a web browser on workstation 130 from a server 110 transmitted over public network 140 (operation 602). Methods and devices for viewing content and rich media such as in an advertisement, other than a web page and browser may also be used. The user may access or link to the web page by any appropriate technique as known such as for example clicking on a link that may be contained in an email, on another web site, in a web-based ad, a result of search using a search engine, or by entering a web address directly. Other techniques for accessing a web page may also be used.

Accessing the web page may in operation 604 activate a GUI for controlling the display of rich media such as GUI 200. In some embodiments, activation of GUI 200 may include displaying an image such as image 10 of FIG. 2 and displaying a message such as message 20, although other images and rich media may also be displayed. This initial activation of GUI may appear to a user as the initial presentation of a physical container or package that has just been delivered to the user. In some embodiments, the package and corresponding image 10 and message 20 may be personalized to the user, although the invention is not limited in this respect. In some alternate embodiments, GUI 200 and the associated rich media objects and/or digital media may be transmitted via for example email to work station 130. Further GUI 200 and associated components may be imported to work station 130 by other mechanisms such as from a CD or a DVD.

Although not shown in FIG. 6, a user may attempt to investigate the contents of the physical container of image 10 by moving a cursor such as cursor 21 over image 10. In response to the placement of cursor 21 over a specific area of image 10, GUI 200 may for example open or show a window such as window 23 containing an icon representing one or more of the contents of the physical container such as for example content icon 24.

Alternatively or additionally, a user may select image 10 in operation 606 to open the package in image 10. Although the invention is not limited in this respect, GUI 200 may display a rich media sequence or object that portrays the container in image 10 being opened.

In operation 608, GUI 200 may display one or more icons such as for example icons 41-44 of FIG. 4. Each icon may represent or be associated with a different item respectively contained in the package of image 10 and may also be a user control for activating a rich media file or object to display the item to a user.

In operation 610, a user may select one of icons 41-44 using a pointing device or other mechanism as known. In response to the user's selection, GUI 200 may display the respective rich media file or object associated with the selected icon such as for example letter 51 of FIG. 5 associated or represented by icon 41 (operation 612). In some embodiments, the associated icon may change in appearance or disappear once GUI 200 displays the rich media file.

A user may decide whether or not to select one or more additional icons in operation 614. If an additional icon is selected, the method may repeat operations 612-616 for each icon so selected until the user is finished with the content being displayed by GUI 200 and the method terminates in operation 616.

Although the particular embodiments shown and described above will prove to be useful for the many systems to which the present invention pertains, further modifications of the present invention will occur to persons skilled in the art. All such modifications are deemed to be within the scope and spirit of the present invention as defined by the appended claims.

What is claimed is:

1. A method for generating a graphical user interface (GUI) at a client on a network, the method comprising:
generating an image of a physical container, the container capable of being opened;
displaying one or more icons associated with the physical container, the one or more icons associated respectively with one or more rich media objects;
wherein the GUI displays a rich media object associated with an icon when said icon is selected.

2. The method of claim 1 comprising displaying the icons when a user selects the image of the physical container.

3. The method of claim 2 wherein the user selects the image of the physical container by moving a cursor over the image.

4. The method of claim 1 comprising storing the one or more rich media objects represented by the one or more icons on a machine-readable medium at a server on the network.

5. The method of claim 4 comprising sending the one or more rich media objects represented by the one or more icons from the server to the client on the network.

6. The method of claim 1 wherein the physical container is an unopened envelope.

7. The method of claim 6 wherein the GUI displays an image of a letter when an icon associated with the letter is selected by the user.

8. The method of claim 7 wherein the GUI displays an image of a first page of the letter and an indicator for selecting a second page of the letter, the image and the means displayed when an icon associated with the letter is selected by the user; and wherein the GUI displays an image of a second page of the letter when the second page of the letter is selected with said indicator.

9. The method of claim 6 wherein the GUI plays a media file when an icon associated with the media file is selected by the user.

10. The method of claim 1 wherein at least one of the rich media objects is personalized to the user.

11. The method of claim 1 wherein each of the one or more icons associated with the unopened object is associated with respectively one or more distinct areas of the image of the physical container, and comprising displaying each of the one or more icons if a cursor moved by a user is over the respective distinct area of the image of the physical container.

12. A machine readable medium having stored thereon executable code which causes a machine to perform a method for generating a graphical user interface (GUI) the method comprising:
generating an image of a physical container, the container capable of being opened;
displaying one or more icons associated with the unopened object, the one or more icons associated respectively with one or more rich media objects;
wherein the GUI displays a rich media object associated with an icon when said icon is selected.

13. The machine-readable medium of claim 12, wherein said method comprises:
displaying the icons when a user selects the image of the physical container.

14. The machine-readable medium of claim 12, wherein the GUI plays a media file when an icon associated with the media file is selected by the user.

15. The machine-readable medium of claim 12, wherein at least one of the rich media objects is personalized to the user.

16. A system for generating a graphical user interface (GUI) at a client on a network, the method comprising:
a server for hosting a web site;
a client for operating a web browser to access the web site, wherein the web browser is configured for:
generating an image of a physical container, the container capable of being opened;
displaying one or more icons associated with the unopened object, the one or more icons associated respectively with one or more rich media objects;
wherein the GUI displays a rich media object associated with an icon when said icon is selected.

17. The system of claim 16, wherein the browser is configured for:
displaying the icons when a user selects the image of the physical container.

18. The system of claim 16 wherein the one or more rich media objects represented by the one or more icons are stored on a machine-readable medium at the server on the network.

19. The system of claim 16 wherein the GUI plays a media file when an icon associated with the media file is selected by the user.

20. The system of claim 16 wherein at least one of the rich media objects is personalized to the user.
